(19) United States
(12) Patent Application Publication
(10) Pub. No.: US 2012/0038307 A1
(43) Pub. Date: Feb. 16, 2012

(54) Measurement System Using Alignment Unit And Method Of Determining System Parameters Of Alignment Unit

(75) Inventors: Sung Min Ahn, Suwon-si (KR); Seung Won Yang, Seoul (KR); Tae Kyu Son, Seongnam-si (KR)

(73) Assignee: SAMSUNG ELECTRONICS CO., LTD., Suwon-si (KR)

(21) Appl. No.: 13/184,784

(22) Filed: Jul. 18, 2011

(30) Foreign Application Priority Data
Aug. 11, 2010 (KR) 10-2010-0077255

(51) Int. Cl. G05B 1/01

(52) U.S. Cl. 318/640

(57) ABSTRACT

In one embodiment a method determines a system parameter of an alignment unit in a system that measures a position and posture of a workpiece, such as a substrate (or a semiconductor wafer), using the alignment unit. A mounting error of the alignment unit is determined, and a real system parameter value of the alignment unit is determined based on the mounting error, thereby accurately measuring position and posture information of the workpiece.

### CROSS-REFERENCE TO RELATED APPLICATION(S)

This application claims the benefit of Korean Patent Application No. 2010-0077255, filed on Aug. 11, 2010 in the Korean Intellectual Property Office, the disclosure of which is incorporated herein by reference in its entirety.

### BACKGROUND

1. Field

Embodiments relate to a method of determining a system parameter of an alignment unit in a system that measures the position and posture of a workpiece, such as a substrate (or a semiconductor wafer), using the alignment unit.

2. Description of the Related Art

Generally, the position and posture of a workpiece, such as a substrate (or a semiconductor wafer) constituting a liquid crystal display (LCD), a plasma display panel (PDP) or a flat panel display (FPD), are measured so as to process, manufacture or inspect the workpiece. To this end, the position and posture of the workpiece are measured using an alignment unit, such as a microscope system.

When the position and posture of the workpiece are measured using the alignment unit, the alignment unit is mounted to coincide with a moving table on which the workpiece is placed in the horizontal and vertical directions so as to accurately measure position and posture information of the workpiece.

In actuality, however, the alignment unit is not always mounted correctly. That is, the alignment unit does not coincide with the moving table in the horizontal and vertical directions. For this reason, it may be necessary to calculate a mounting error of the mounted alignment unit. In particular, when a plurality of alignment units are mounted so as to enable position and posture information of the workpiece to be rapidly measured, it may be necessary to calculate mounting errors of the respective alignment units.

### SUMMARY

At least one embodiment provides a method of determining a real system parameter value of an alignment unit used to measure a position and posture of a workpiece, such as a substrate (or a semiconductor wafer) based on a mounting error of the alignment unit during assembly and mounting thereof.

Additional aspects of the embodiments will be set forth in part in the description which follows and, in part, will be obvious from the description, or may be learned by practice of the invention.

According to one embodiment, a method of determining at least one system parameter of an alignment unit that measures a position and posture of a workpiece placed on a moving table includes measuring a position of a fiducial mark formed on the moving table using the alignment unit, determining a mounting error of the alignment unit by moving the moving table such that the fiducial mark is located within a field of view of the alignment unit, determining the system parameter of the alignment unit by moving the moving table in a direction changed in correspondence to the calculated mounting error, and acquiring a first set of coordinate positions of the fiducial mark before and after movement of the moving table.

The moving table may have two degrees of freedom in which the moving table moves in X- and Y-directions.

The moving table may have three degrees of freedom in which the moving table moves in X-, Y- and Z-directions.

The determining a mounting error of the alignment unit may include moving the moving table in an X- or Y-direction of a coordinate system of stage such that the fiducial mark is located within the field of view of the alignment unit to acquire a second set of coordinate positions of the fiducial mark at a start position and an end position, and determining horizontal and vertical mounting errors of the alignment unit based on the second set of coordinate positions. The moving table is supported by the stage.

The determining a mounting error of the alignment unit may include repeatedly moving the moving table in the X- or Y-direction of the stage coordinate system a number of times at intervals to acquire first means of coordinate positions of the fiducial mark, and determining horizontal and vertical mounting errors of the alignment unit based on the first means.

The determining a mounting error of the alignment unit may include calculating a final mounting error of the alignment unit using the horizontal and vertical mounting errors of the alignment unit.

The determining the system parameter of the alignment unit may include moving the moving table in parallel to a horizontal direction of an view coordinate system using the mounting error to acquire at least a portion of the first set of coordinate positions of the fiducial mark at the start position and the end position, and determining a horizontal system parameter of the alignment unit based on the first set of coordinate positions.

The determining the system parameter of the alignment unit may include moving the moving table in parallel to a vertical direction of an view coordinate system using the mounting error to acquire at least a portion of the first set of coordinate positions of the fiducial mark at the start position and the end position, and determining a vertical system parameter of the alignment unit based on the first set of coordinate positions.

The determining the system parameter of the alignment unit may include repeatedly moving the moving table in parallel to at least one of the horizontal and vertical direction of the view coordinate system a number of times at intervals to acquire second means of coordinate positions of the fiducial mark, and determining horizontal and vertical system parameters of the alignment unit based on the second means.

The horizontal and vertical system parameters of the alignment unit may include a scale factor having a unit of length/pixel with respect to each direction in the field of view of the alignment unit.

In another example embodiment, a measurement system includes a table configured to move a workpiece, an alignment unit configured to measure a position of a fiducial mark formed on the table, and a controller. The controller is configured to move the table such that the fiducial mark is located within a field of view of the alignment unit, configured to calculate a mounting error of the alignment unit, and configured to determine a system parameter of the alignment unit by moving the table in a direction changed in correspondence to the mounting error and by acquiring a first set of coordinate positions of the fiducial mark before and after movement of the moving table.

The alignment unit may be plural in number.

The alignment unit may include a scope to measure coordinate positions of the fiducial mark.

The controller may be configured to move the table in an X- or Y-direction of a coordinate system of a stage such that the fiducial mark is located within the field of view of the alignment unit to acquire a second set of coordinate positions of the fiducial mark at a start position and an end position, and may be configured to calculate horizontal and vertical mounting errors of the alignment unit based on the second set of coordinate positions. The table is supported by the stage,

The controller may be configured to repeatedly move the table in the X- or Y-direction of the stage coordinate system a number of times at intervals to acquire first means of coordinate positions of the fiducial mark, and to determine horizontal and vertical mounting errors of the alignment unit based on the first means.

The controller may be configured to calculate a final mounting error of the alignment unit using the horizontal and vertical mounting errors of the alignment unit.

The controller may be configured to move the table in parallel to a horizontal direction of a view coordinate system using the mounting error to acquire at least a portion of the first set of coordinate positions of the fiducial mark at the start position and the end position, and to determine a horizontal system parameter of the alignment unit based on the first set of coordinate positions.

The controller may be configured to move the table in parallel to a vertical direction of a view coordinate system using the mounting error to acquire at least a portion of the first set of coordinate positions of the fiducial mark at the start position and the end position, and to determine a vertical system parameter of the alignment unit based on the first set of coordinate positions.

The controller may be configured to repeatedly move the table in parallel to at least one of the horizontal and vertical direction of the view coordinate system a number of times at intervals to acquire second means of coordinate positions of the fiducial mark, and to determine horizontal and vertical system parameters of the alignment unit based on the second means.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is an overall construction view of a measurement system according to an embodiment;

FIG. 2 is an operation conceptual view of the measurement system according to the embodiment;

FIG. 3 is a control construction view of the measurement system according to an embodiment;

FIG. 4 is a first view illustrating a mark position measured by a k-th alignment unit mounted in the measurement system according to an embodiment;

FIG. 5 is a second view illustrating a mark position measured by the k-th alignment unit mounted in the measurement system according to an embodiment;

FIG. 6 is a view illustrating a process of calculating an alignment unit mounting error using a fiducial mark in the measurement system according to an embodiment;

FIG. 7 is a view illustrating a process of calculating an alignment unit mounting error in the horizontal direction using a fiducial mark in the measurement system according to an embodiment;

FIG. 8 is a view illustrating a process of calculating the mean of alignment unit mounting errors in the horizontal direction using fiducial marks in the measurement system according to an embodiment;

FIG. 9 is a view illustrating a process of calculating an alignment unit mounting error in the vertical direction using a fiducial mark in the measurement system according to an embodiment;

FIG. 10 is a view illustrating a process of calculating the mean of alignment unit mounting errors in the vertical direction using fiducial marks in the measurement system according to an embodiment;

FIG. 11 is a view illustrating a process of calculating a real system parameter of an alignment unit in the horizontal direction using an alignment unit mounting error in the measurement system according to an embodiment;

FIG. 12 is a view illustrating a process of calculating the mean of real system parameters of an alignment unit in the horizontal direction using an alignment unit mounting error in the measurement system according to an embodiment;

FIG. 13 is a view illustrating a process of calculating a real system parameter of an alignment unit in the vertical direction using an alignment unit mounting error in the measurement system according to an embodiment; and

FIG. 14 is a view illustrating a process of calculating the mean of real system parameters of an alignment unit in the vertical direction using an alignment unit mounting error in the measurement system according to an embodiment.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

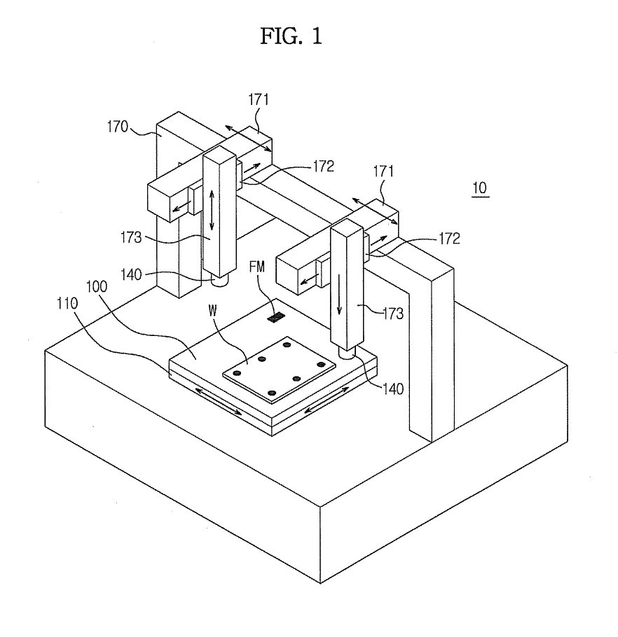

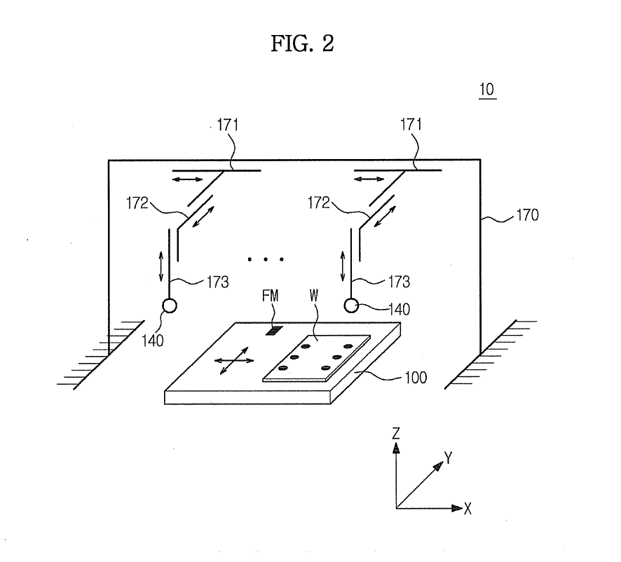

FIG. 1 is an overall construction view of a measurement system 10 according to an embodiment, and FIG. 2 is an operation conceptual view of the measurement system 10 according to the embodiment.

Referring to FIGS. 1 and 2, the measurement system 10 includes a moving table 100 on which a workpiece (a sample, such as a wafer or glass, on which a desired or predetermined pattern is to be formed) W is placed and a plurality of alignment units 140 mounted above the moving table 100 to measure a position and posture of the workpiece W placed on the moving table 100. The alignment units 140 are mounted to a gantry 170 such that the alignment units 140 move in X-, Y- and Z-directions. The alignment units 140 have three degrees of freedom (X, Y, Z), which is the most common configuration. The degrees of freedom may be restricted. For example, the alignment units 140 may have a degree of freedom in the X-, Y- or Z-direction.

Guide bar type moving members 171, 172 and 173 are mounted to the gantry 170 such that the moving members 171, 172 and 173 move in the X-, Y- or Z-direction. The alignment units 140 are coupled to the moving members 171, 172 and 173 such that the alignment units 140 are moved in the X-, Y- or Z-direction.

Each alignment unit 140 has three degrees of freedom (X, Y, Z) in which each alignment unit 140 moves in the X-, Y- and Z-directions according to the movements of the moving members 171, 172 and 173. The moving table 100, on which the workpiece W is placed, has two degrees of freedom (X, Y) in which the moving table 100 moves in the X- and Y-directions according to the movement of a stage 110.

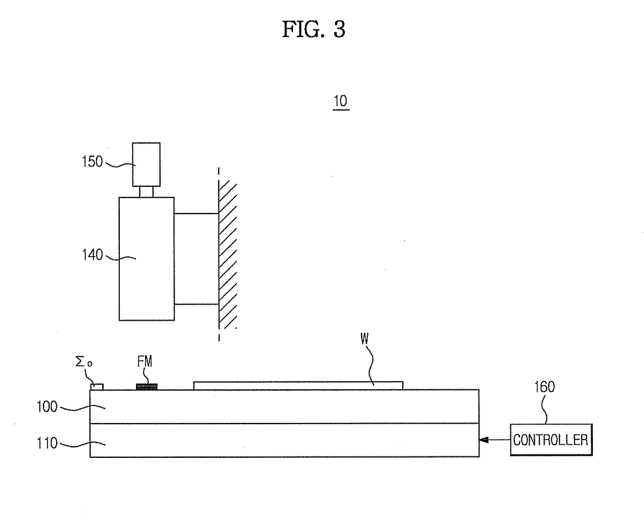

FIG. 3 is a control construction view of the measurement system 10 according to an embodiment.

Referring to FIG. 3, the measurement system 10 includes a stage 110, alignment units 140, mark capturing units 150, and a controller 160.

The stage 110 is a device to move the moving table 100, on which the workpiece W is placed, in the X- and Y-directions. The stage 110 moves the moving table 100 according to an instruction from the controller 160 such that a fiducial mark FM formed on the moving table 100 is located within a field of view F.O.V of each alignment unit 140.

The alignment units 140 may be scopes provided above the stage 110 to measure the position of the fiducial mark FM formed on the moving table 100.

Each mark capturing unit 150 is provided above a corresponding one of the alignment units 140 to capture the fiducial mark FM formed on the moving table 100 and transmit the captured image to the controller 160. A capturing unit 150 may transmit the image wirelessly or over a wired connection (not shown). At this time, the movement of the stage 110 is controlled according to an instruction from the controller 160 until the fiducial mark FM is captured by the mark capturing unit 150.

The controller 160 calculates real system parameter values based on assembly and mounting of the respective alignment units 140 using fiducial marks FM measured by the alignment units 140. In the measurement system 10, in which the moving table 100 and the respective alignment units move in their degrees of freedom, the position and posture of the workpiece W is measured as follows. A mounting error y of each alignment unit 140 with respect to the moving table 100 is calculated, the moving table 100 is moved in a direction changed in correspondence to the calculated mounting error y, and coordinate positions of the fiducial mark FM on an view coordinate system Σ_{V} before and after movement of the moving table are acquired, thereby calculating real system parameters of each alignment unit 140 in the horizontal and vertical directions.

That is, the controller 160 acquires coordinate positions of the fiducial mark FM at start and end positions while moving the moving table 100 in parallel to the horizontal and vertical directions of the view coordinate system Σ_{V} using the calculated mounting error y, thereby calculating system parameters, i.e., unit scale factors, of each alignment unit 140 in the horizontal and vertical directions.

Hereinafter, a method of calculating a real system parameter value of each alignment unit 140 in the measurement system 10 will be described.

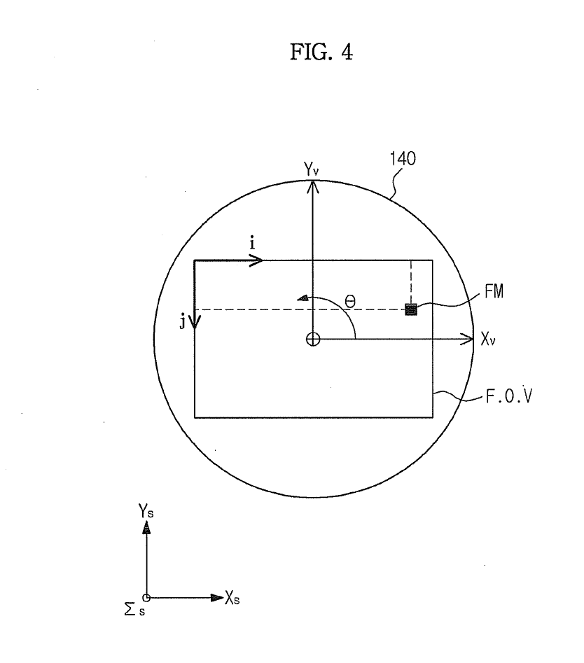

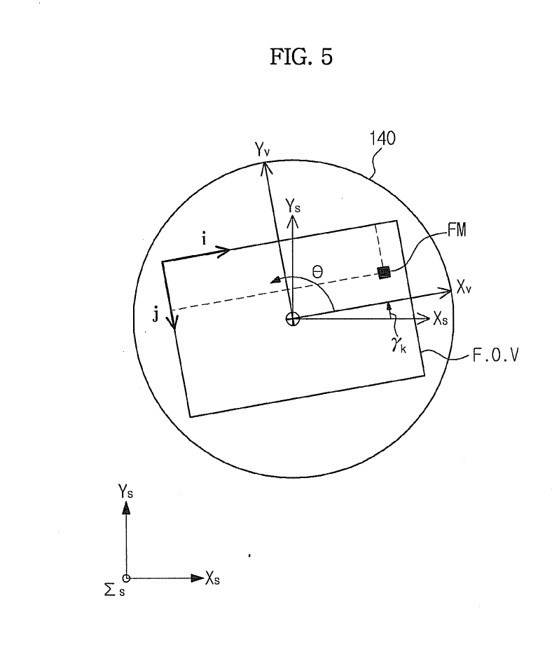

FIG. 4 is a first view illustrating a mark position measured by a k-th alignment unit mounted in the measurement system according to the an embodiment, and FIG. 5 is a second view illustrating a mark position measured by the k-th alignment unit mounted in the measurement system according to an embodiment.

Referring to FIGS. 4 and 5, a fiducial mark FM formed on the moving table 100 within a field of view F.O.V of a k-th alignment unit 140 is measured. Physical quantities defined to measure the fiducial mark FM are as follows.

Σ_{S}(X_{S}, Y_{S}) is a body fixed coordinate system of the stage 110 (hereinafter, referred to as a stage coordinate system).

Σ_{V}(X_{V}, Y_{V}) is a body fixed coordinate system of the k-th alignment unit 140 (hereinafter, referred to as an view coordinate system).

FIG. 4 shows that the k-th alignment unit 140 is ideally mounted. The k-th alignment unit 140 coincides in posture with the stage coordinate system Σ_{S}. That is, the mounting error yₖ of the alignment unit 140 is 0.

FIG. 5 shows that the k-th alignment unit 140 is generally mounted. The k-th alignment unit 140 is assembled or mounted at an angle having a mounting error yₖ with respect to the stage coordinate system Σ_{S}.

Generally, each alignment unit 140 is not mounted so as to coincide in posture with the stage coordinate system Σ_{S} as shown in FIG. 4 but at an angle having a mounting error yₖ with respect to the stage coordinate system Σ_{S} as shown in FIG. 5.

Due to the mounting error yₖ, the position and posture of the workpiece W placed on the moving table 100 may not be accurately measured by each alignment unit 140. For this reason, it may be necessary to calculate a real system parameter value of each alignment unit 140 with respect to the mounting error yₖ.

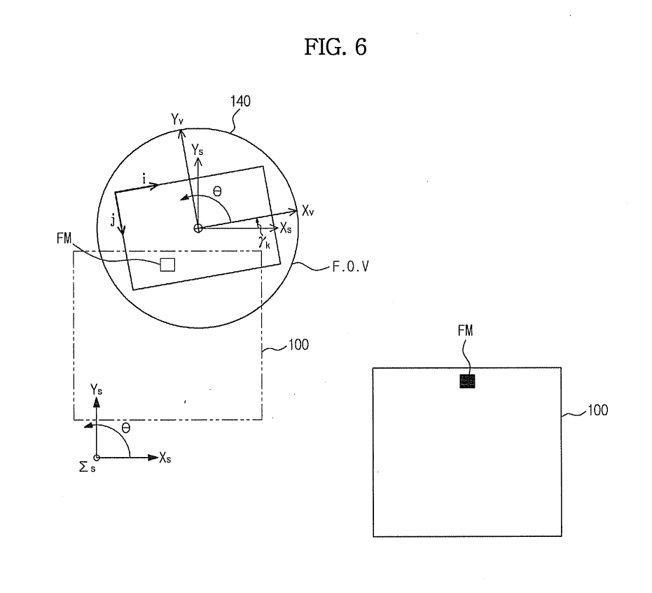

To this end, a mounting error yₖ generated when an alignment unit 140 is mounted with respect to the stage coordinate system Σ_{S} is calculated first, which will be described with reference to FIG. 6.

FIG. 6 is a view illustrating a process of calculating an alignment unit mounting error using a fiducial mark in the measurement system according to an embodiment.

It is assumed that the alignment unit of FIG. 6 is a k-th alignment unit 140.

A mounting error yₖ of the k-th alignment unit 140 is calculated while the moving table 100 is moved such that a fiducial mark FM formed on the moving table 100 is located within a field of view F.O.V of the k-th alignment unit 140.

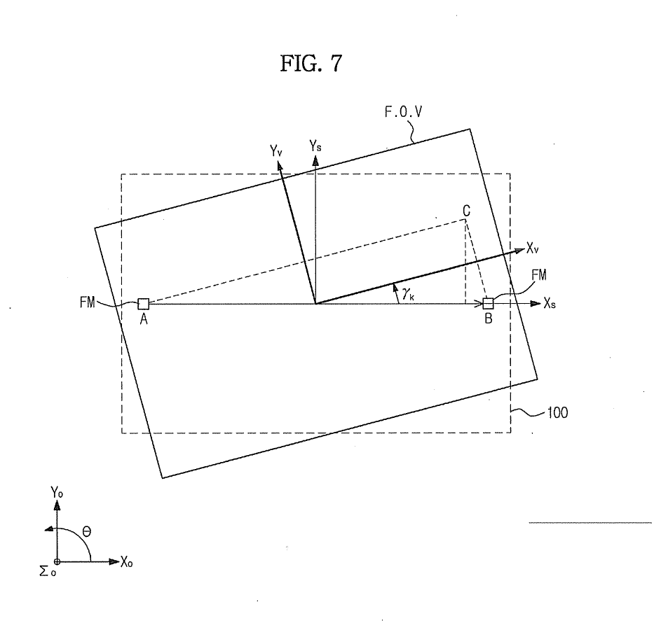

The details thereof will be described in more detail with reference to FIGS. 7 to 10.

FIG. 7 is a view illustrating a process of calculating an alignment unit mounting error in the horizontal direction using a fiducial mark in the measurement system according to an embodiment.

Referring to FIG. 7, physical quantities defined to calculate a horizontal mounting error (hereinafter, referred to as a horizontal error) ^{hori}yₖ of the k-th alignment unit 140 are as follows.

Σ_{O}(X_{O}, Y_{O}) is a fiducial coordinate system in which the position and posture of the workpiece W placed on the moving table 100 are acquired. Σ_{O}(X_{O}, Y_{O}) is provided on the moving table 100 (see FIG. 3).

First, the moving table 100 is moved from position A to position B in the X-direction (horizontal direction) on the stage coordinate system Σ_{S}, and coordinate positions of the fiducial mark FM on the view coordinate system Σ_{V} before and after movement of the moving table 100 are measured using the alignment unit 140.

The horizontal error ^{hori}yₖ of the k-th alignment unit 140 based on coordinate variations of the fiducial mark FM on the view coordinate system Σ_{V} before and after movement of the moving table 100 is calculated as represented by Equation 1 below.

$${}_{}^{hori}{γ}{}_{k}^{} = - {tan}^{- 1} \frac{BC}{A C} = - {tan}^{- 1} ( \frac{{Δ}^{v} y}{{Δ}^{v} x} ) \qquad [ Equation 1 ]$$

In Equation 1, Δ^{V}X is a horizontal variation of the fiducial mark FM measured on the view coordinate system Σ_{V} before and after movement of the moving table 100, and Δ^{V}y is a vertical variation of the fiducial mark FM measured on the view coordinate system Σ_{V} before and after movement of the moving table 100.

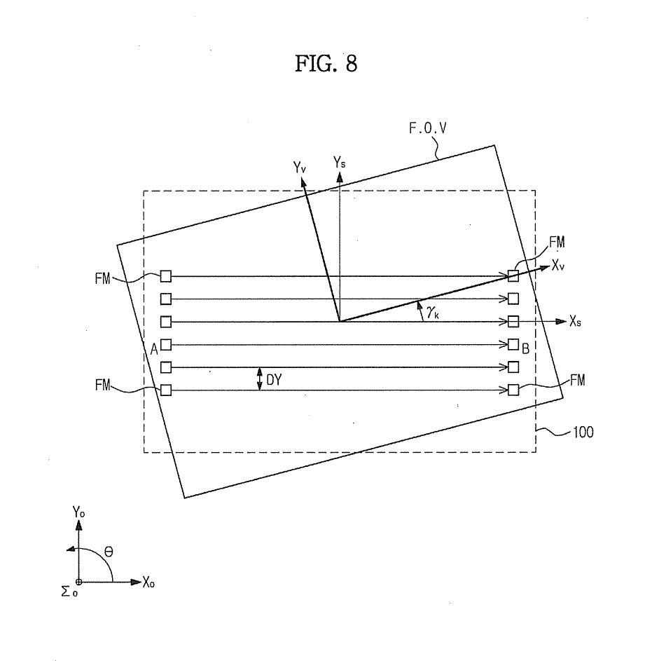

FIG. 8 is a view illustrating a process of calculating the mean of alignment unit mounting errors in the horizontal direction using fiducial marks in the measurement system according to an embodiment.

Referring to FIG. 8, the moving table 100 is moved from position A to position B in the X-direction (horizontal direction) on the stage coordinate system Σ_{S}, and the moving table 100 is moved in the X-direction (horizontal direction) in parallel to AB at regular or known intervals in the Y-direction (for example, intervals of DY).

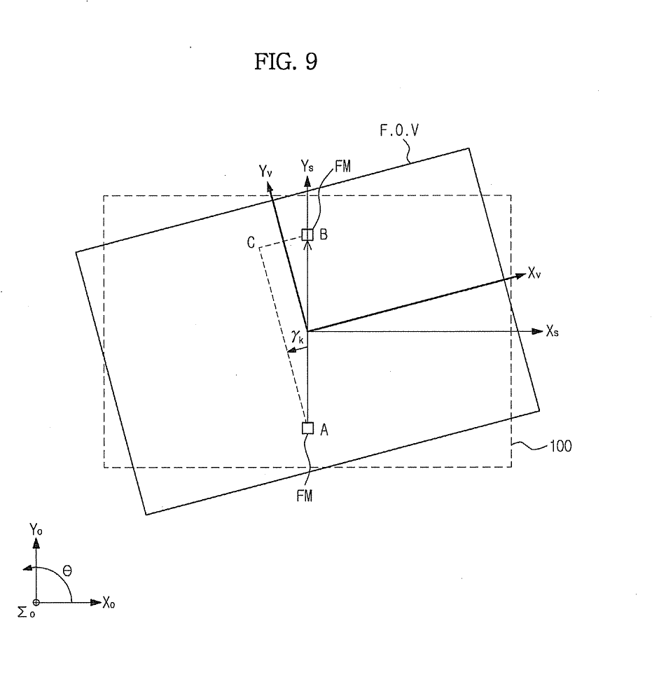

The moving table 100 is repeatedly moved in the X-direction (horizontal direction) in parallel to AB at regular or known intervals (intervals of DY) in the Y-direction within a field of view F.O.V of the k-th alignment unit 140 a desired (or, alternatively, a predetermined) number of times n to calculate the mean M of horizontal errors ^{hori}yₖ of the k-th alignment unit 140 as represented by Equation 2 (see FIG. 9).

$${M}^{hori} {y}_{k} = \frac{1}{n} {\sum }^{hori} {y}_{k} \qquad [ Equation 2 ]$$

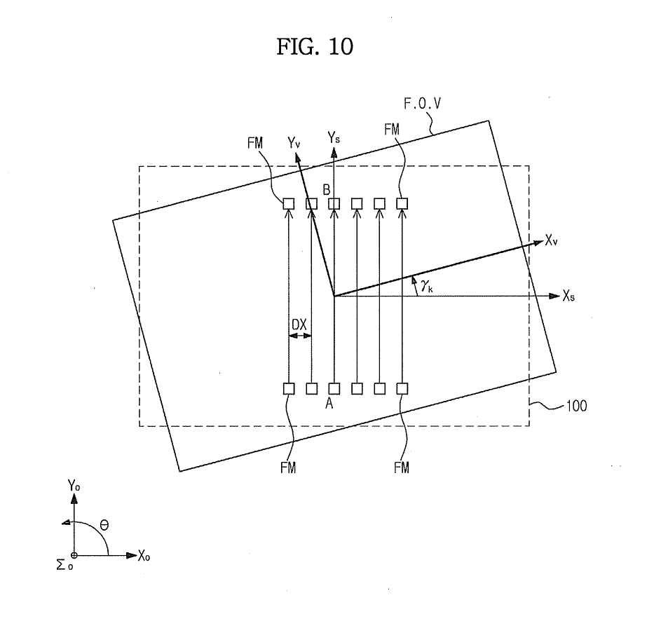

In the same manner as the method shown in FIGS. 7 and 8, a vertical mounting error (hereinafter, referred to as a vertical error) ^{vert}yₖ of the k-th alignment unit 140 may be calculated, which will be described in more detail with reference to FIGS. 9 and 10.

FIG. 9 is a view illustrating a process of calculating an alignment unit mounting error in the vertical direction using a fiducial mark in the measurement system according to an embodiment.

Referring to FIG. 9, the moving table 100 is moved from position A to position B in the Y-direction (vertical direction) on the stage coordinate system Σ_{S}, and coordinate positions of the fiducial mark FM on the view coordinate system Σ_{V} before and after movement of the moving table 100 are measured using the alignment unit 140.

The vertical error ^{vert}yₖ of the k-th alignment unit 140 based on coordinate variations of the fiducial mark FM on the view coordinate system Σ_{V} before and after movement of the moving table 100 is calculated as represented by Equation 3 (see FIG. 9).

$${}_{}^{vort}{γ}{}_{k}^{} = - {tan}^{- 1} \frac{BC}{A C} = - {tan}^{- 1} ( \frac{{Δ}^{v} y}{{Δ}^{v} x} ) \qquad [ Equation 3 ]$$

In Equation 3, Δ^{V}X is a horizontal variation of the fiducial mark FM measured on the view coordinate system Σ_{V} before and after movement of the moving table 100, and Δ^{V}y is a vertical variation of the fiducial mark FM measured on the view coordinate system Σ_{V} before and after movement of the moving table 100.

FIG. 10 is a view illustrating a process of calculating the mean of alignment unit mounting errors in the vertical direction using fiducial marks in the measurement system according to an embodiment.

Referring to FIG. 10, the moving table 100 is moved from A to B in the Y-direction (vertical direction) on the stage coordinate system Σ_{S}, and the moving table 100 is moved in the Y-direction (vertical direction) in parallel to AB at regular or known intervals (for example, intervals of DX) in the X-direction.

The moving table 100 is repeatedly moved in the Y-direction (vertical direction) in parallel to AB at regular intervals (for example, intervals of DX) in the X-direction within a field of view. F.O.V of the k-th alignment unit 140 a desired (or, alternatively, a predetermined) number of times n to calculate the mean M of vertical errors ^{vert}yₖ of the k-th alignment unit 140 as represented by Equation 4.

$${M}^{vert} {y}_{k} = \frac{1}{n} {\sum }^{vert} {y}_{k} \qquad [ Equation 4 ]$$

The horizontal error ^{hori}yₖ calculated by Equation 2 and the vertical error ^{vert}yₖ calculated by Equation 4 are compared using Equation 5 to check perpendicularity of the stage.

$$\frac{{M}^{vert} {y}_{k}}{{M}^{hori} {y}_{k}} \approx 1 \qquad [ Equation 5 ]$$

After perpendicularity of the stage is checked using Equation 5, a final mounting error yₖ of the k-th alignment unit 140 is calculated using Equation 6.

$${y}_{k} = \frac{1}{2} ( {M}^{hori} {y}_{k} + {M}^{vert} {y}_{k} ) \qquad [ Equation 6 ]$$

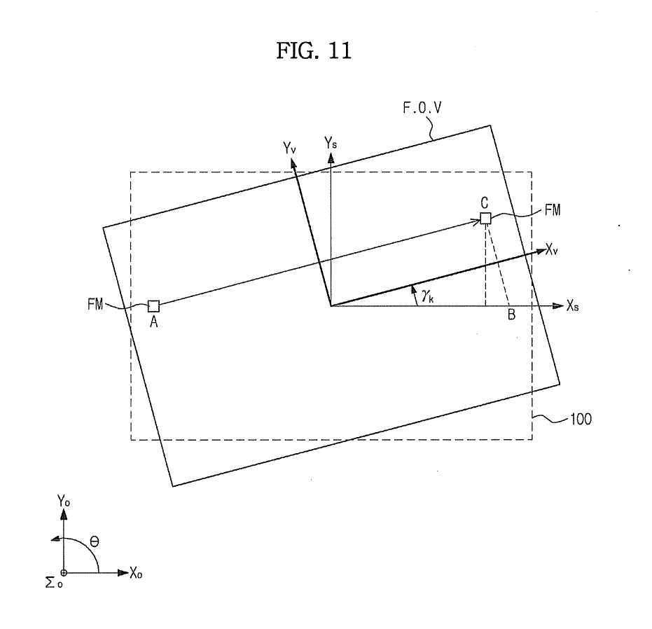

When the final mounting error yₖ of the k-th alignment unit 140 is calculated, the moving table 100 is moved in a direction changed in correspondence to the calculated mounting error yₖ, and coordinate positions of the fiducial mark FM on the view coordinate system Σ_{V} of a field of view F.O.V measured by the k-th alignment unit 140 before and after movement of the moving table 100 are acquired, thereby calculating real system parameters of the k-th alignment unit 140 in the horizontal and vertical directions, which will be described with reference to FIGS. 11 to 14.

FIG. 11 is a view illustrating a process of calculating a real system parameter of an alignment unit in the horizontal direction using an alignment unit mounting error in the measurement system according to an embodiment.

Referring to FIG. 11, the moving table 100 is moved from position A to position C in a direction changed in correspondence to the calculated mounting error yₖ from the X-direction (horizontal direction) on the stage coordinate system Σ_{S}, and coordinate positions of the fiducial mark FM on the view coordinate system Σ_{V} before and after movement of the moving table 100 are measured using the alignment unit 140.

In other words, the moving table 100 is moved from position A to position C in parallel to the X-direction (horizontal direction) of the view coordinate system Σ_{V} using the calculated mounting error yₖ, and coordinate positions of the fiducial mark FM at the start position A and the end position C are measured using the alignment unit 140.

The start position A and the end position C of the fiducial mark FM on the stage coordinate system Σ_{S} are acquired as represented by Equation 7.

$$start pos = {}^{S} [ \begin{matrix}{X}_{S} \\ {Y}_{S}\end{matrix} ] \\ end pos = {}^{S} [ \begin{matrix}{X}_{S} + {l}_{AB} {cos}^{2} {γ}_{k} \\ {Y}_{S} + {l}_{AB} sin {γ}_{k} cos {γ}_{k}\end{matrix} ] \qquad [ Equation 7 ]$$

A real horizontal parameter Sₓ(Sₕ, Sᵢ) of the k-th alignment unit 140 is calculated as represented by Equation 8 using the coordinate positions, i.e., the start position A and the end position C, of the fiducial mark FM measured on the view coordinate system Σ_{V} before and after movement of the moving table 100 as represented by Equation 7 (see FIG. 11).

$$∴ {S}_{x} ≡ \frac{{}_{}^{S}{l}{}_{A C}^{}}{{}_{}^{V}{l}{}_{A C}^{}} = \frac{{}_{}^{S}{l}{}_{AB}^{} cos {γ}_{k}}{{}_{}^{V}{l}{}_{A C}^{}} \qquad [ Equation 8 ]$$

In Equations 7 and 8, the left superscript of each parameter indicates a fiducial coordinate system.

For example, ^{S}I_{AC} indicates the length (mm) of a straight line AC on the stage coordinate system Σ_{S}, and ^{V}I_{AC} indicates the length (pixel) of a straight line AC on the view coordinate system Σ_{V}.

The real horizontal parameter Sₓ(Sₕ, Sᵢ) of the k-th alignment unit 140 calculated by Equation 8 is a scale factor having a unit of length/pixel, such as um/pixel or nm/pixel.

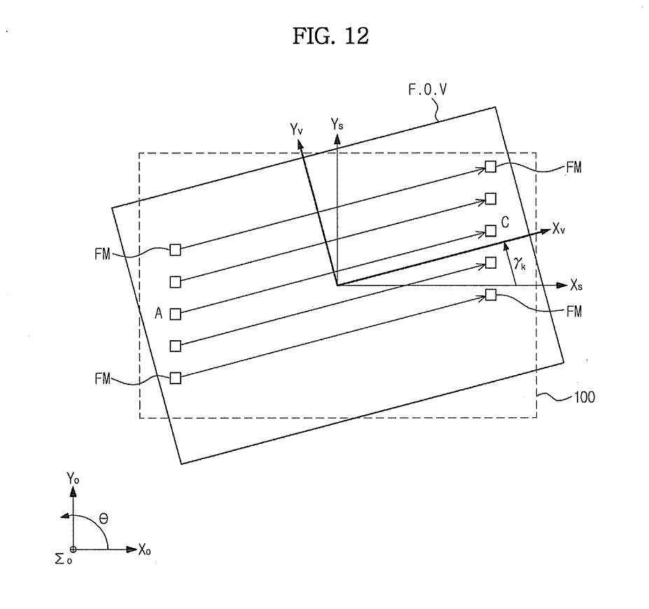

Also, the mean of horizontal parameters Sₓ(Sₕ, Sᵢ) of the k-th alignment unit 140 may be calculated in the same manner as in calculating the mounting error yₖ of the k-th alignment unit 140, which will be described with reference to FIG. 12.

FIG. 12 is a view illustrating a process of calculating the mean of real system parameters of an alignment unit in the horizontal direction using an alignment unit mounting error in the measurement system according to an embodiment.

Referring to FIG. 12, the moving table 100 is moved from position A to position C in the X-direction (horizontal direction) on the view coordinate system Σ_{V}, and the moving table 100 is moved in the X-direction (horizontal direction) in parallel to AC at regular or known intervals in the Y-direction.

The moving table 100 is repeatedly moved in the X-direction (horizontal direction) in parallel to AC at regular intervals in the Y-direction within a field of view F.O.V of the k-th alignment unit 140 several times to repeatedly measure real horizontal parameters Sₓ(Sₕ, Sᵢ) of the k-th alignment unit 140, thereby calculating the mean M thereof as represented by Equation 9 (see FIG. 12).

$${MS}_{x} \frac{1}{n} {\sum }_{i} {( {S}_{x} )}_{i} \qquad [ Equation 9 ]$$

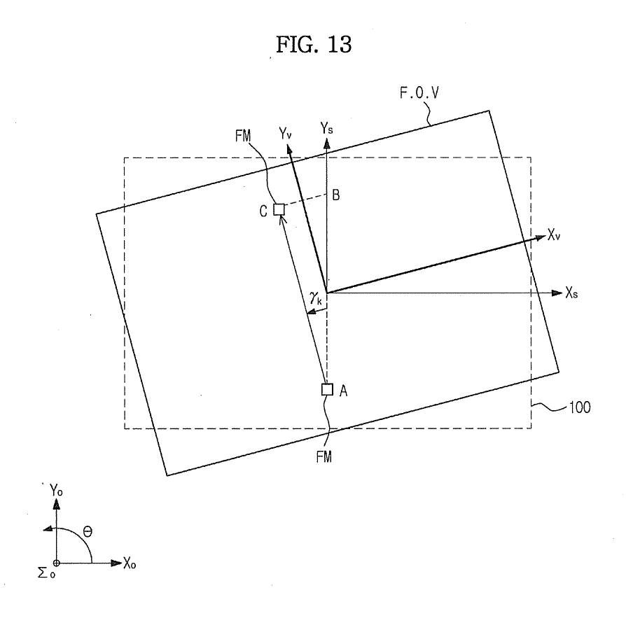

FIG. 13 is a view illustrating a process of calculating a real system parameter of an alignment unit in the vertical direction using an alignment unit mounting error in the measurement system according to an embodiment.

Referring to FIG. 13, the moving table 100 is moved from A to C in a direction changed in correspondence to the calculated mounting error yₖ from the Y-direction (vertical direction) on the stage coordinate system Σ_{S}, and coordinate positions of the fiducial mark FM on the view coordinate system Σ_{V} before and after movement of the moving table 100 are measured using the alignment unit 140.

In other words, the moving table 100 is moved from position A to position C in parallel to the Y-direction (vertical direction) of the view coordinate system Σ_{V} using the calculated mounting error yₖ, and coordinate positions of the fiducial mark FM at the start position A and the end position C are measured using the alignment unit 140.

The start position A and the end position C of the fiducial mark FM on the stage coordinate system Σ_{S} are acquired as represented by Equation 10.

$$start pos = {}^{S} [ \begin{matrix}{X}_{S} \\ {Y}_{S}\end{matrix} ] \\ end pos = {}^{S} [ \begin{matrix}{X}_{S} + {l}_{AB} cos {γ}_{k} sin {γ}_{k} \\ {Y}_{S} + {cos}^{2} {γ}_{k}\end{matrix} ] \qquad [ Equation 10 ]$$

A real vertical parameter S_{y}(Sₕ, Sⱼ) of the k-th alignment unit 140 is calculated as represented by Equation 11 using the coordinate positions, i.e., the start position A and the end position C, of the fiducial mark FM measured on the view coordinate system Σ_{V} before and after movement of the moving table 100 as represented by Equation 10 (see FIG. 13).

$$∴ {S}_{y} ≡ \frac{{}_{}^{S}{l}{}_{A C}^{}}{{}_{}^{V}{l}{}_{A C}^{}} = \frac{{}_{}^{S}{l}{}_{AB}^{} cos {γ}_{k}}{{}_{}^{V}{l}{}_{A C}^{}} \qquad [ Equation 11 ]$$

In Equations 10 and 11, the left superscript of each parameter indicates a fiducial coordinate system.

For example, ^{S}I_{AC} indicates the length (mm) of a straight line AC on the stage coordinate system Σ_{S}, and ^{V}I_{AC} indicates the length (pixel) of a straight line AC on the view coordinate system Σ_{V}.

The real vertical parameter S_{y}(Sₕ, Sᵢ) of the k-th alignment unit 140 calculated by Equation 11 is a scale factor having a unit of length/pixel, such as um/pixel or nm/pixel.

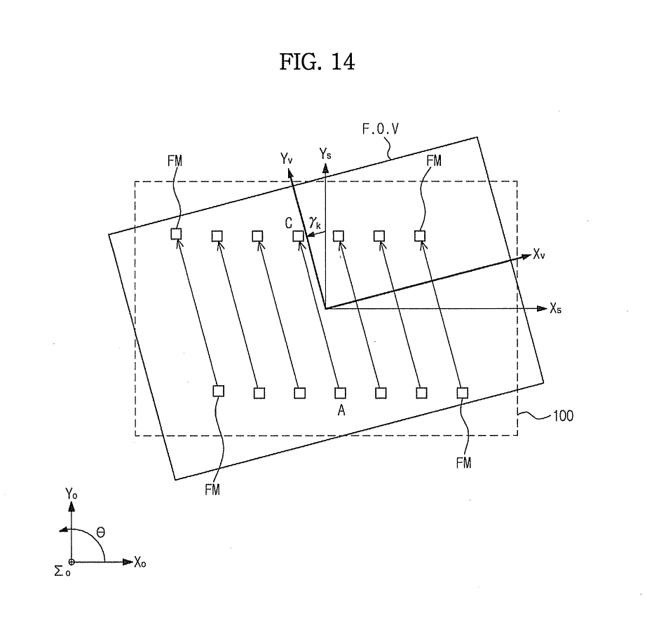

Also, the mean of vertical parameters S_{y}(Sₕ, Sᵢ) of the k-th alignment unit 140 may be calculated in the same manner as in calculating the mounting error yₖ of the k-th alignment unit 140, which will be described with reference to FIG. 14.

FIG. 14 is a view illustrating a process of calculating the mean of real system parameters of an alignment unit in the vertical direction using an alignment unit mounting error in the measurement system according to an embodiment.

Referring to FIG. 14, the moving table 100 is moved from position A to position C in the Y-direction (vertical direction) on the view coordinate system Σ_{V}, and the moving table 100 is moved in the Y-direction (vertical direction) in parallel to AC at regular intervals in the X-direction.

The moving table 100 is repeatedly moved in the Y-direction (vertical direction) in parallel to AC at regular intervals in the X-direction within a field of view F.O.V of the k-th alignment unit 140 several times to repeatedly measure real vertical parameters S_{y}(Sₕ, Sᵢ) of the k-th alignment unit 140, thereby calculating the mean M thereof as represented by Equation 12 (see FIG. 14).

$${MS}_{x} \frac{1}{n} {\sum }_{i} {( {S}_{y} )}_{i} \qquad [ Equation 12 ]$$

In this embodiment, the alignment unit 140 is fixed and the moving table 100 is moved to measure the fiducial mark FM formed on the moving table 100. However, the embodiments are not limited thereto. For example, the moving table 100 may be fixed and the alignment unit 140 may be moved to measure the fiducial mark FM formed on the moving table 100. Alternatively, both the moving table 100 and the alignment unit 140 may be moved to measure the fiducial mark FM formed on the moving table 100.

As is apparent from the above description, a mounting error of the alignment unit used to measure a position and posture of a workpiece, such as a substrate (or a semiconductor wafer), during assembly and mounting thereof is calculated, and a real system parameter value of the alignment unit is calculated based on the calculated mounting error, thereby accurately measuring position and posture information of the workpiece.

Also, in a case in which a plurality of alignment units are provided to measure a position and posture of the workpiece, real system parameter values of the respective alignment units based on mounting errors thereof are calculated, thereby accurately measuring position and posture information of the workpiece within a short time.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of determining at least one system parameter of an alignment unit that measures a position and posture of a workpiece placed on a moving table, comprising:
measuring a position of a fiducial mark formed on the moving table using the alignment unit;
determining a mounting error of the alignment unit by moving the moving table such that the fiducial mark is located within a field of view of the alignment unit;
determining the system parameter of the alignment unit by moving the moving table in a direction changed in correspondence to the calculated mounting error, and by acquiring a first set of coordinate positions of the fiducial mark before and after movement of the moving table.

2. The method according to claim 1, wherein the moving table has two degrees of freedom in which the moving table moves in X- and Y-directions.

3. The method according to claim 1, wherein the moving table has three degrees of freedom in which the moving table moves in X-, Y- and Z-directions.

4. The method according to claim 1, wherein the determining a mounting error of the alignment unit comprises:
moving the moving table in an X- or Y-direction of a coordinate system of a stage such that the fiducial mark is located within the field of view of the alignment unit to acquire a second set of coordinate positions of the fiducial mark at a start position and an end position, the moving table being supported by the stage;
determining horizontal and vertical mounting errors of the alignment unit based on the second set of coordinate positions.

5. The method according to claim 4, wherein the determining a mounting error of the alignment unit comprises:
repeatedly moving the moving table in the X- or Y-direction of the stage coordinate system a number of times at intervals to acquire first means of coordinate positions of the fiducial mark; and
determining horizontal and vertical mounting errors of the alignment unit based on the first means.

6. The method according to claim 5, wherein the determining a mounting error of the alignment unit comprises:
calculating a final mounting error of the alignment unit using the horizontal and vertical mounting errors of the alignment unit.

7. The method according to claim 6, wherein the determining the system parameter of the alignment unit comprises:
moving the moving table in parallel to a horizontal direction of an view coordinate system using the mounting error to acquire at least a portion of the first set of coordinate positions of the fiducial mark at the start position and the end position; and
determining a horizontal system parameter of the alignment unit based on the first set of coordinate positions.

8. The method according to claim 6, wherein the determining the system parameter of the alignment unit comprises:
moving the moving table in parallel to a vertical direction of an view coordinate system using the mounting error to acquire at least a portion of the first set of coordinate positions of the fiducial mark at the start position and the end position; and
determining a vertical system parameter of the alignment unit based on the first set of coordinate positions.

9. The method according to claim 7, wherein the determining the system parameter of the alignment unit comprises:
repeatedly moving the moving table in parallel at least one of to the horizontal and vertical direction of the view coordinate system a number of times at intervals to acquire second means of coordinate positions of the fiducial mark; and
determining horizontal and vertical system parameters of the alignment unit based on the second means.

10. The method according to claim 8, wherein the determining the system parameter of the alignment unit comprises:
repeatedly moving the moving table in parallel to at least one of the horizontal and vertical direction of the view coordinate system a number of times at intervals to acquire second means of coordinate positions of the fiducial mark, thereby determining horizontal and vertical system parameters of the alignment unit based on the second means.

11. The method according to claim 7, wherein the horizontal and vertical system parameters of the alignment unit comprise a scale factor having a unit of length/pixel with respect to each direction in the field of view of the alignment unit.

12. The method according to claim 8, wherein the horizontal and vertical system parameters of the alignment unit comprise a scale factor having a unit of length/pixel with respect to each direction in the field of view of the alignment unit.

13. A measurement system comprising:
a table configured to move a workpiece;
an alignment unit configured to measure a position of a fiducial mark formed on the table; and
a controller configured to move the table such that the fiducial mark is located within a field of view of the alignment unit, configured to calculate a mounting error of the alignment unit, and configured to determine a system parameter of the alignment by moving the table in a direction changed in correspondence to the mounting error and by acquiring a first set of coordinate positions of the fiducial mark before and after movement of the moving table.

14. The measurement system according to claim 13, wherein the table has two degrees of freedom in which the moving table moves in X- and Y-directions.

15. The measurement system according to claim 13, wherein the table has three degrees of freedom in which the moving table moves in X-, Y- and Z-directions.

16. The measurement system according to claim 13, wherein the alignment unit is plural in number.

17. The measurement system according to claim 13, wherein the alignment unit comprises a scope to measure coordinate positions of the fiducial mark.

18. The measurement system according to claim 13, wherein the controller is configured to move the table in an X- or Y-direction of a coordinate system of a stage such that the fiducial mark is located within the field of view of the alignment unit to acquire a second set of coordinate positions of the fiducial mark at a start position and an end position, and to calculate horizontal and vertical mounting errors of the alignment unit based on the second set of coordinate positions, the table being supported by the stage.

19. The measurement system according to claim 18, wherein the controller is configured to repeatedly move the table in the X- or Y-direction of the stage coordinate system a number of times at intervals to acquire first means of coordinate positions of the fiducial mark, and to determine horizontal and vertical mounting errors of the alignment unit based on the first means.

20. The measurement system according to claim 19, wherein the controller is configured to calculate a final mounting error of the alignment unit using the horizontal and vertical mounting errors of the alignment unit.

21. The measurement system according to claim 20, wherein the controller is configured to move the table in parallel to a horizontal direction of a view coordinate system using the mounting error to acquire at least a portion of the first set of coordinate positions of the fiducial mark at the start position and the end position, and to determine a horizontal system parameter of the alignment unit based on the first set of coordinate positions.

22. The measurement system according to claim 20, wherein the controller is configured to move the table in parallel to a vertical direction of a view coordinate system using the mounting error to acquire at least a portion of the first set of coordinate positions of the fiducial mark at the start position and the end position, and to determine a vertical system parameter of the alignment unit based on the first set of coordinate positions.

23. The measurement system according to claim 21, wherein the controller is configured to repeatedly move the table in parallel to at least one of the horizontal and vertical direction of the view coordinate system a number of times at intervals to acquire second means of coordinate positions of the fiducial mark, and to determine horizontal and vertical system parameters of the alignment unit based on the second means.

24. The measurement system according to claim 22, wherein the controller is configured to repeatedly move the table in parallel to at least one of the horizontal and vertical direction of the view coordinate system a number of times at intervals to acquire second means of coordinate positions of the fiducial mark, and to determine horizontal and vertical system parameters of the alignment unit based on the second means.
